(19) United States
(12) Patent Application Publication
(10) Pub. No.: US 2014/0125778 A1
(43) Pub. Date: May 8, 2014

(54) SYSTEM FOR PRODUCING STEREOSCOPIC IMAGES WITH A HOLE FILLING ALGORITHM AND METHOD THEREOF

(71) Applicant: Electronics and Telecommunications Research Institute, Daejeon (KR)

(72) Inventors: Hae Dong KIM, Daejeon (KR); Yun Ji BAN, Daejeon (KR); Hye Sun KIM, Daejeon (KR); Jung Jae YU, Seongnam-si (KR); Kyung Ho JANG, Daegu (KR); Myung Ha KIM, Daejeon (KR); Joo Hee BYON, Daejeon (KR); Seung Woo NAM, Daejeon (KR)

(73) Assignee: Electronics and Telecommunications Research Institute, Daejeon (KR)

(21) Appl. No.: 13/905,824

(22) Filed: May 30, 2013

(30) Foreign Application Priority Data
Nov. 5, 2012 (KR) 10-2012-0124294

(51) Int. Cl. H04N 13/00

(52) U.S. Cl. CPC H04N 13/0033
USPC 348/51

(57) ABSTRACT

Disclosed are a system for producing stereoscopic images with a hole filling algorithm, and a method thereof. A system for producing stereoscopic images according to an exemplary embodiment of the present invention includes: a movement area detecting unit examining a movement area for an object moved in an image, detecting/tracking changes of the movement area by dividing a front view and a background of the movement area, and providing result information; a filling error processing unit filling a hole detected by the movement area detecting unit and correcting a filled filling region; and a stereoscopic image visualizing unit visualizing a stereoscopic image corrected by the filling error processing unit.

### CROSS-REFERENCE TO RELATED APPLICATIONS

This application claims priority to and the benefit of Korean Patent Application No. 10-2012-0124294 filed in the Korean Intellectual Property Office on Nov. 5, 2012, the entire contents of which are incorporated herein by reference.

### TECHNICAL FIELD

The present invention relates to production of stereoscopic images, and more particularly, to a system for producing stereoscopic images with a hole filling algorithm to fill a hole by moving an object in the stereoscopic images, which may occur depending on creation of the stereoscopic images or a change in depth effect in the stereoscopic images, and a method thereof.

### BACKGROUND

In the case of a stereoscopic image as an image which seems to be present in a 3D space, a method for actually reproducing a 3-dimensional (3D) image is also attempted, but a widely studied method presents the same image as being viewed in left and right directions to left and right eyes to make both eyes to be different from each other in viewpoint and synthesizes the viewpoints to be viewed as one stereoscopic image.

That is, the stereoscopic image both left and right eyes are separately created, and as a result, a left eye can watch a left image and a right eye can watch a right image at the same time to be stereoscopically felt. Producing the stereoscopic image is divided into a method for photographing the left and right images by using stereoscopic image cameras capable of photographing the left and right images, respectively, a method for rendering the images produced by using 3D graphic software by setting a virtual camera or lens in software to the left eye and the right eye, and a conversion process of creating an image at an opposite side (left eye or right eye) based on an image photographed or produced by using a single lens.

Among them, the method of creating the image at the opposite side based on a single image and converting the created image into the stereoscopic image generally includes an automatic conversion method of separating the single image for each frame by a hardware system or a software system and designating prior and post frames to left and right images, respectively to simultaneously reproduce the images, and a non-real time method of producing a depth map based on a sequence of images extracted from the single image and producing the image at the opposite side based on the depth map to integrate the image and the depth map which are reproduced, and the image is converted and used through various other methods.

A specialist such as a stereographer who manages a lot of time, equipment, and expression of a depth effect is required in stereoscopic photographing, and since it is not easy to verify a desired depth effect or a stereoscopic effect in a film site, there is a case in which a user intends to change the depth effect (stereoscopic effect) in accordance with an effect desired to be expressed in an output environment. In the change in depth effect in the related art, a method of warping an image depending on a movement direction, such as horizontal image transform (HIT) is used, but the method is limited in expressing the stereoscopic effect, and as a result, a depth effect similar to actual photographing may be expressed through movement of an object depending on a depth, but a hole which is generated between movement areas needs to be filled.

Even in converting a single-eye image into a binocular stereoscopic image, filling the gap between the movement areas of the object, which occurs while moving an object in the single-eye image to a position viewed in both eyes, comes to the forefront. In the related art, manual processing based on an experience of a production specialist is performed in order to produce a high-quality stereoscopic image, but consistent hole filling between frames is not achieved. Therefore, a flickering phenomenon occurs in the stereoscopic image, and as a result, a visual fatigue is increased.

Consequently, the necessity for a system or a method that can fill the gap between the object areas, which occurs by movement of the image in the stereoscopic image, comes to the forefront.

### SUMMARY

The present invention has been made in an effort to provide a system for producing stereoscopic images with a hole filling algorithm to fill a hole by moving an object in the stereoscopic images, which may occur depending on creation of the stereoscopic images or a change in depth effect in the stereoscopic images, and a method thereof.

The present invention has also been made in an effort to provide a system for producing stereoscopic images with a hole filling algorithm to produce an optimal stereoscopic image in combination with a user's intuitive judgment, and a method thereof.

An exemplary embodiment of the present invention provides a system for producing stereoscopic images, including: a movement area detecting unit examining a movement area for an object moved in an image, detecting/tracking changes of the movement area by dividing a front view and a background of the movement area, and providing result information; a filling error processing unit filling a hole detected by the movement area detecting unit and correcting a filled filling region; and a stereoscopic image visualizing unit visualizing a stereoscopic image corrected by the filling error processing unit.

The movement area detecting unit may include a movement area examining unit calculating the movement area by using a difference between segmentation of the object and a change area of the segmented object; a front view and background dividing unit processing the calculated movement area as a background for the object and processing the moved object as a front view; a movement area change detecting unit examining whether the object and the movement area are changed for each frame; and a movement area tracking unit tracking the object when the object is changed.

The system may further include a filling guide unit providing a filling guide corresponding to result information based on the result information for the movement area and the filling error processing unit may correct the filling region based on the filling guide provided by the filling guide unit.

The filling guide unit may include a boundary guide unit providing a visual image of a boundary portion of the object; a filling method guide unit providing at least one filling method guide for the movement area; a boundary blurring guide unit providing a guide for blurring the boundary area; a filling candidate guide unit providing a predetermined filling method guide for a predetermined specific frame; and a human factor guide unit providing an error allowance guide to a focus area and a non-focus area of the image based on recognition).

The filling error processing unit may include a boundary information processing unit analyzing and processing boundary information in accordance with a predetermined value; a filling method processing unit setting values required for interpolation, transform, and tracking by using information which is provided in advance and filling the movement area in accordance with the set values; and a boundary blurring unit setting and processing a boundary blurring value in accordance with information which is provided in advance.

The filling error processing unit may further include a filling information selecting unit filling and simulating the filled hole in accordance with predetermined filling information to provide the filled and simulated hole to a user.

The stereoscopic image visualizing unit may include a depth information visualizing unit visualizing an initial depth feeling provided by the user and depth information utilized when the movement area is filled; a stereoscopic image visualizing unit visualizing a stereoscopic image considering the movement area; an unstable area visualizing unit determining a depth feeling in the image and visualizing an unstable area in the image based on the determined depth feeling; and a final image visualizing unit visualizing a final image in which the movement area is filled.

Another exemplary embodiment of the present invention provides a method for producing stereoscopic images, including: examining a movement area for an object moved in an image, detecting/tracking changes of the movement area by dividing a front view and a background of the movement area, and providing result information; filling a hole detected and correcting a filled filling region based on the result information; and visualizing the corrected stereoscopic image.

The providing may include calculating the movement area by using a difference between segmentation of the object and a change area of the segmented object; processing the calculated movement area as a background for the object and processing the moved object as a front view; examining whether the object and the movement area are changed for each frame; and tracking the object when the object is changed.

The method may further include providing a filling guide corresponding to result information based on the result information for the movement area, and in the correcting, the filling region may be corrected based on the filling guide.

According to the exemplary embodiments of the present invention, since a hole can be filled by movement of an object in the stereoscopic image, which may occur depending on creation of the stereoscopic image or a change in depth effect in the stereoscopic image, it is possible to give lots of help in producing a lot of stereoscopic image contents.

In particular, the present invention uses a method of effectively filling the hole depending on a difference in movement degrees image objects of objects in an image, which is one of parts requiring a time at the time of producing the stereoscopic image, in combination with a user's appropriate judgment through visual suggestion, allows the method to be applied to the production of the stereoscopic image even in various scenes, and thus it is possible to decrease a time required to produce the stereoscopic image.

According to the exemplary embodiments of the present invention, a stereoscopic image in which a visual fatigue is minimized can be produced by considering a human factor, and as a result, the present invention can be used in various fields such as a movie, a game, an advertisement, scientific visualization, and the like.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 illustrates a configuration for a system for producing stereoscopic images according to an exemplary embodiment of the present invention.

FIG. 2 illustrates a configuration of an exemplary embodiment for a movement area detecting unit illustrated in FIG. 1.

FIG. 3 illustrates a configuration of an exemplary embodiment for a filling guide unit illustrated in FIG. 1.

FIG. 4 illustrates a configuration of an exemplary embodiment for a filling error processing unit illustrated in FIG. 1.

FIG. 5 illustrates a configuration of an exemplary embodiment for a stereoscopic image visualizing unit illustrated in FIG. 1.

FIG. 6 illustrates an operational flowchart for a method for producing stereoscopic images according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings.

Other objects and features of the present invention other than the object will be apparently revealed through description of exemplary embodiments which refer to the accompanying drawings.

Terms used in the specification are just used to describe illustrative exemplary embodiments and are not to be construed as limiting the present invention. Singular expression includes plural expressions as long as the expressions do not have apparently different contextual meanings. In this specification, terms such as ‘comprise’, ‘include’, or ‘have’ are used to designate presence of implemented features, figures, steps, operations, elements, parts, or combinations thereof and it should be understood that presence or addition possibilities of presence or addition possibilities of other features or figures, steps, operations, elements, parts, or combinations thereof are not excluded in advance.

If not differently defined, all terms used herein, which include technical or scientific terms have the same meanings as those generally appreciated by those skilled in the art. It should be understood that terms defined in advance, which are generally used have the same meanings as contextual meanings of associated techniques and if not apparently defined in this application, the terms are not ideally or excessively analyzed as formal meanings.

Exemplary embodiments of the present invention will be described in detail with reference to the accompanying drawings. When it is determined that the detailed description of the known art related to the present invention may obscure the gist of the present invention, the detailed description thereof will be omitted.

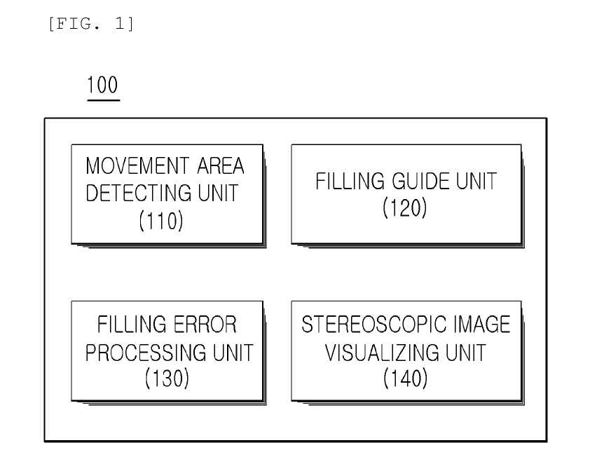

Hereinafter, a system for producing stereoscopic images with a hole filling algorithm and a method thereof according to exemplary embodiments of the present invention will be described in detail with reference to FIGS.1 to 6.

The present invention uses a method of effectively filling the hole depending on a difference in movement degrees of image objects, which is one of parts requiring time at the time of producing the stereoscopic image, in combination with a user's appropriate judgment through visual suggestion, and as a result, allows the method to be applied to the production of the stereoscopic image even in various scenes to be applied to production of a lot of stereoscopic image contents.

The largest feature of the present invention relates to production of the stereoscopic image and may be configured by a system which includes both conversion of a depth effect of a stereoscopically photographed image and conversion of a single-eye image into a stereoscopic image, provides a user interface for sufficiently utilizing user's experience information for the depth effect which a human recognizes through visualization information, and is applicable to production of various stereoscopic images as guide information and visualization information which help the user interface.

FIG. 1 illustrates a configuration for a system for producing stereoscopic images according to an exemplary embodiment of the present invention.

Referring to FIG. 1, a system 100 according to an exemplary embodiment of the present invention includes a movement area detecting unit 110, a filling guide unit 120, a filling error processing unit 130, and a stereoscopic image visualizing unit 140.

The movement area detecting unit 110, as a configuration that detects an area for an object moved in an image, examines a movement area and detects/tracks movement area changes by dividing a front view and a background of the movement area to provide result information.

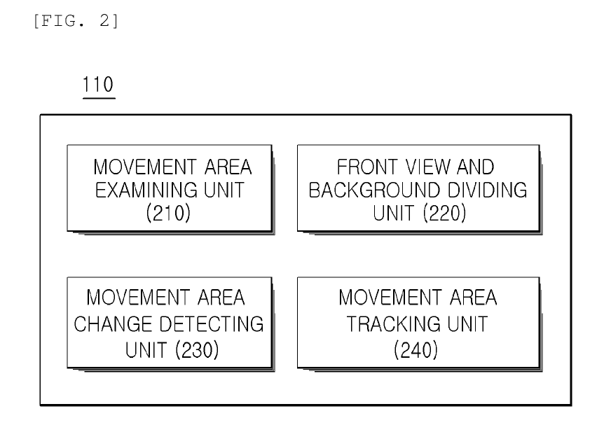

The movement area detecting unit 110 includes a movement area examining unit 210, a front view and background dividing unit 220, a movement area change detecting unit 230, and a movement area tracking unit 240, as illustrated in FIG. 2.

The movement area examining unit 210 serves to acquire a hole region by movement of an object.

In this case, the movement area examining unit 210 may acquire the hole region by the movement of the object through movement information for each object provided while a depth effect is changed in binocular images and acquire the hole region by movement through an original image and a changed image in conversion of a monocular image.

The front view and background dividing unit 220, as a configuration that divides the front view and the background of the movement area, may divide the front view and the background by using information on the movement object and divide the front view and the background through a change in a depth map for each object.

The movement area change detecting unit 230, as a configuration that detects whether the change occurs among respective frames, may have the same condition as a photographed camera if there is no change.

In this case, the object may be considered as a stop object in the case of a scene in which the camera is fixed and an object which is moved parallel to the camera in the case of a scene in which the camera is moved.

The movement area tracking unit 240 tracks the movement object for each frame.

Herein, the movement area tracking unit 240 may utilize the existing object tracking technology and utilize an appropriate tracking technology based on accumulation accuracy.

The movement area tracking unit 240 may perform accurate hole filling without flickering through accurate tracking using the appropriate tracking technology.

As such, the movement area detecting unit 110 calculates the movement area by a difference by accurate segmentation of the movement object and change areas of the segmented objects through the movement area examining unit 210, serves to process the area calculated by the movement area examining unit 210 as the background for the movement object and process the area as the front view for the movement object through the front view and background dividing unit 220, examines whether the movement object and the movement area are changed for each frame, through the movement area change detecting unit 230, and performs accurate object tracking when the object is changed, through the movement area tracking unit 240 to accurately calculate the movement area for each frame. That is, the movement area detecting unit 110 may perform accurate processing for the movement area by using accurate object segmentation and object tracking and thus improve image quality.

The filling guide unit 120 provides a filling guide corresponding to a scene acquired based on analysis information depending on various scenes which are analyzed in advance.

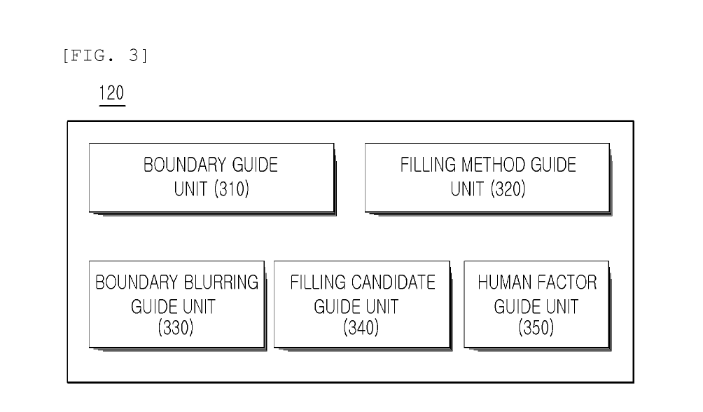

Herein, the filling guide unit 120, as means for assisting user selection processing by providing a guide which is required in advance for each scene, includes a boundary guide unit 310, a filling method guide unit 320, a boundary blurring guide unit 330, a filling candidate guide unit 340, and a human factor guide unit 350, as illustrated in FIG. 3.

Since a range of an area to be filled or an area to be acquired as filling candidate information may depend on a processing amount of information on a boundary portion of the object, the boundary guide unit 310 provides a visual image of the boundary portion associated with the range to allow a user to select an appropriate range of a boundary.

Herein, a value for the boundary range of the image may be set to a predetermined basic value.

The filling method guide unit 320 brings information from the same frame or a plurality of frames and provides a guide regarding how to fill the brought information.

Herein, a method of filling the image in the movement area may be generally divided into a method of bringing information from a single image, a method of bringing information from the plurality of frames, and a method of using third information.

The method of bringing the information from the single image may be primarily used when the movement area is able to be processed by interpolation of a surrounding image as continuation of a neighboring area, an interpolation method may include a rapid and simple linear interpolation method, a mathematical polynomial expression interpolation method, or an interpolation method by a spline function, or the like, and may be processed by selecting interpolation most suitable for a change progress of the image. The method of bringing the information from the plurality of frames may be used when the neighboring area of the movement area is changed to bring information of the movement area of a current frame from another frame.

The boundary blurring guide unit 330 provides a function to alleviate inaccuracy of a boundary area through blurring and make boundaries be smoothly viewed, and provides a guide of blurring for the boundary area.

In this case, when a boundary blurring area is enlarged, the definition of the image deteriorates as much, and as a result, the boundary blurring guide unit 330 may perform blurring of the boundary more largely as the inaccuracy of the boundary area is higher based on a boundary size of an original image. Of course, a reference to judge whether the boundary area is inaccurate may be determined by a stereoscopic image producer or a stereoscopic image producing enterprise.

The filling candidate guide unit 340 provides a guide for the method of using the third information.

Herein, in the method of using the third information, a case in which there are a lot of errors in interpolation by neighboring information and there is not related information in various frames occurs primarily when information on a movement area corresponding to the side surface of the rectangular parallelepiped moved from the front side of the rectangular parallelepiped may not be known the case where the monocular image in which a front side of a rectangular parallelepiped having a complicated texture is viewed closely is converted into a stereoscopic 3D image in which side surfaces of the rectangular parallelepiped are viewed, as a representative case and in this case, when the user fills the movement area in terms of a common sense and the movement area is changed for each frame as necessary, the resulting filled area may also be processed to be changed in accordance with a change type.

The filling method guide unit 320 and the filling candidate guide unit 340 have a complementary relationship with each other, and may fill the information in a predetermined frame (key frame) by using the filling candidate guide unit 340 and fill the information in the remaining frames by using the filling method guide unit 320.

The human factor guide unit 350 performs a function to provide different error allowance guides to a focus area and a non-focus area of the image based on recognition, respectively to improve the quality of the produced stereoscopic image.

Herein, the human factor guide unit 350 keeps an error allowance range to be narrow for the focus area requiring the definition and allows the error allowance range to be enlarged for the non-focus area to be enlarged to refer to the areas in the boundary blurring guide unit 330.

As such, the human factor guide unit 350 is a configuration for producing a high-quality stereoscopic image by considering a recognitive aspect of the image.

The filling error processing unit 130 serves to set and process a filling guide for filling the hole which occurs by movement of the object in the stereoscopic image.

In this case, the filling error processing unit 130 may set and process the filling guide based on information provided from the filling guide unit 120, information provided from the stereoscopic image visualizing unit 140, and an experience of a stereoscopic image producer.

When the movement area is filled through the setting and processing of the filling guide, the filling error processing unit 130 supplements flickering which occurs due to an interframe error for an area filled by correcting the filled area.

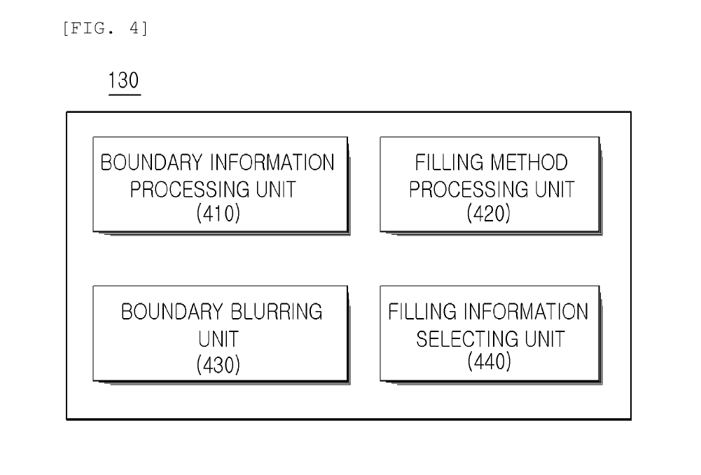

The filling error processing unit 130 includes a boundary information processing unit 410, a filling method processing unit 420, a boundary blurring unit 430, and a filling information selecting unit 440, as illustrated in FIG. 4.

The boundary information processing unit 410 analyzes and processes boundary information in accordance with a set value by using the information provided from the boundary guide unit 310.

The filling method processing unit 420 serves to set values required for interpolation, transform, and tracking by using the information provided from the filling method guide unit 320 and fill the movement area in accordance with the set values.

The boundary blurring unit 430 serves to set and process a boundary blurring value in accordance with the information provided from the boundary blurring guide unit 330.

The filling information selecting unit 440 serves to perform filling, and simulate and show the filled area by using filling information selected by the producer or automatically selected depending on the hole which occurs by the movement of the object, and the filled area is processed as necessary.

The stereoscopic image visualizing unit 140 may assist visualization of an anticipated analysis result of the result selected by the stereoscopic image producer and judging whether the stereoscopic image is produced normally in accordance with the producer's intention through visualization of the result. That is, the stereoscopic image visualizing unit 140 visualizes the stereoscopic image processed by the filling error processing unit 130.

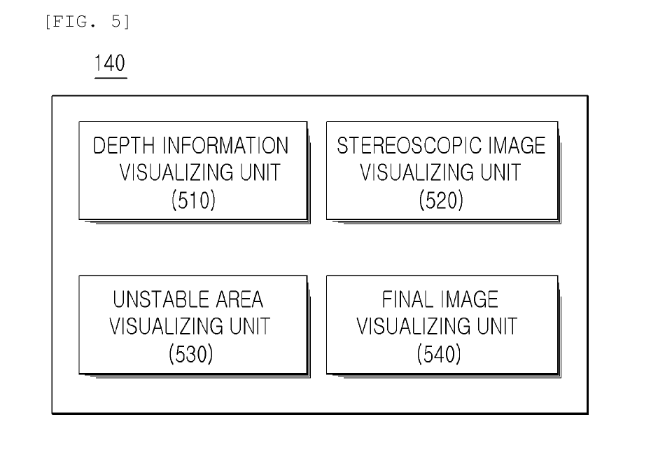

The stereoscopic image visualizing unit 140 includes a depth information visualizing unit 510, a stereoscopic image visualizing unit 520, an unstable area visualizing unit 530, and a final image visualizing unit 540, as illustrated in FIG. 5.

The depth information visualizing unit 510 visualizes information on an initial depth feeling provided by the user and a depth feeling utilized when the movement area is filled.

In this case, the depth information visualizing unit 510 visualizes the depth information set/processed by the user when the depth information is not provided.

The stereoscopic image visualizing unit 520 visualizes the movement area as the stereoscopic image or visualizes the stereoscopic image considering the movement area.

Herein, the stereoscopic image visualizing unit 520 may process an area, which is not filled, as an undetermined color (for example, a black) which is defined in advance by the user or a system when the movement area is not filled.

The unstable area visualizing unit 530, as a configuration that may determine the depth information in the image and visualizes and provides an unstable area when a screen size and distance information from a viewer are provided, may process the unstable area based on a binocular interval of a human by regarding the viewer as the human when there is provided no particular setting and visualize the unstable area as a binocular interval of a specific viewer is provided.

Herein, the unstable area may be determined based on the determined depth information, a setting reference for the unstable area may be decided by the user, and the setting reference for the unstable area may be set as a case in which the depth information is equal to or less than a predetermined value. Of course, a reference and a method for setting the unstable area may depend on the circumstances.

The final image visualizing unit 540 visualizes a final image in which the movement area is filled and when the user performs another setting, the final image visualizing unit 540 visualizes and provides another final image subjected to filling processing in accordance with the setting.

As described above, the present invention includes the filling error processing unit 130 that processes problems of changing the depth feeling of the image which is stereoscopically photographed by using the movement area detecting unit 110 and filling the hole which occurs in the stereoscopic image conversion of the monocular image, and decides/processes the filling method by using the user interface through help from the filling guide unit 120 and the stereoscopic image visualizing unit 140 and thus may be configured to be applied to the production of various stereoscopic images.

As such, the system for producing stereoscopic images according to the present invention fills the hole by the movement of the object in the stereoscopic image which may occur by the production of the stereoscopic image or the change in depth feeling in the stereoscopic image to shorten the stereoscopic image production time and give a lot of help to producing the stereoscopic image contents.

According to the present invention, the stereoscopic image in which the visual fatigue is minimized may be produced by considering the human factor through the user interface.

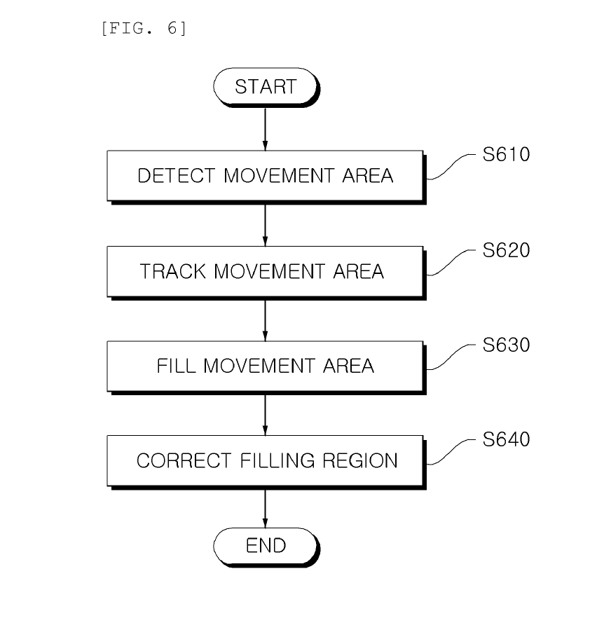

FIG. 6 illustrates an operational flowchart for a method for producing stereoscopic images according to an exemplary embodiment of the present invention.

Referring to FIG. 6, in the method for producing stereoscopic images according to the exemplary embodiment of the present invention, a movement area by movement of an object is detected in a stereoscopic image (S610).

In this case, in step S610, the depths of pixels in the image may be calculated through the relationship between a binocular camera and the binocular image in the case of the binocular image, the movement area may be detected by calculating a changed location of a corresponding pixel by the binocular camera which is change, and the movement area is calculated by a difference between initial object information and movement object information in the case of the binocular image and the initial object information part except for the movement object information may be detected as the movement area.

When the movement area is detected, the detected movement area is tracked (S620).

Herein, the tracking of the movement area (S620) is similar to repeated execution of the detecting of the movement area (S610), but since the same information is not provided in all frames, the movement area may be calculated in a similar manner even in a subsequent frame by using initial information and change information of the subsequent frame. A change of the movement area is tracked by the tracking of the movement area (S620) and tracking result information may be provided.

In steps S610 and S620, the movement area is calculated by using a difference by segmentation of the object and a change area of the segmented object, the calculated movement area is processed as a background for the object, and the movement object is processed as a front view, and the object is tracked when the object is changed by examining whether the object and the movement area are changed for each frame.

Next, the movement area is filled by the interpolation/transform/tracking method for the detected movement area and the movement area tracked for each frame (S630).

Herein, the filling of the movement area (S630) may be performed by a user's selection by using a user interface.

For example, the filling of the movement area is processed by setting a filling method selected by a user depending on a scene, and filling guide information depending on the scene may be additionally provided to help the user's setting of the filling method, and result information when the movement area is filled in accordance with the selected filling method may be visualized as an image to be provided.

In this case, a filling guide may provide a filling guide corresponding to result information based on the result information for the movement area, and the filling guide may be provided by a process of providing a visible image of a boundary portion of the object, at least one filling-method guide for the movement area, a guide for blurring of a boundary area, a predetermined filling method guide with respect to a predetermined specific frame, and an error allowance guide with respect to a focus area and a non-focus area of the image based on recognition.

When the movement area is filled, flickering is supplemented, which is caused due to an interframe error for an area filled by correcting the filling region (S640).

In this case, the correcting of the filling region may include image blurring and the filling region may be corrected based on the filling guide.

In the correcting of the filling region (S640), the filling region may also be additionally corrected by using the user interface.

For example, when a result of the filling of the movement area is good, the filling region is corrected in accordance with a filling correction value of setting the filling method selected by the user interface and when the filling result of the movement area is not good or the correction result is not good, the process returns to the detecting of the movement area (S610), which may be repeatedly performed by more accurately reinforcing the detection of the movement area added with object segmentation/tracking information. That is, it is possible to produce a stereoscopic image which satisfies the user through the user's input.

Herein, the correcting of the filling region (S640) may include analyzing and processing boundary information in accordance with a predetermined value, setting values required for interpolation, transform, and tracking by using information provided in advance and filling the movement area in accordance with the set values, setting and processing a boundary blurring value in accordance with information provided in advance, and filling and simulating a hole in accordance with predetermined filling information to provide the filled and simulated hole to the user.

The stereoscopic image is visualized in order to correct the filling region to help a stereoscopic image producer to produce a satisfactory stereoscopic image.

Herein, the visualizing of the stereoscopic image may include visualizing an initial depth feeling provided by the user and depth information utilized when the movement area is filled, visualizing the stereoscopic image considering the movement area, determining the depth feeling in the image, visualizing an unstable area in the image based on the determined depth feeling, and visualizing a final image in which the movement area is filled.

When the correcting of the filling region is terminated, a final stereoscopic image may be acquired.

In the method of the present invention, an initial binocular image, initial binocular camera information, and changed binocular camera information may be provided or an initial monocular image and movement object information, and object information after movement may be basically provided. The reason is that when the depth information is given in both eyes and a single eye, information processing becomes easier and when a depth relationship between the movement object and the movement area is given in the monocular image, processing may become more accurate.

As such, in the method for producing stereoscopic images according to the present invention, the movement area is filled by maximally utilizing the user's experience through processing the movement area of the stereoscopic image using the user interface to minimize a problem in which a lot of processing errors occur depending on the scene, and as a result, the method is used for general production of the stereoscopic image and may support producing a high-quality stereoscopic image based on providing intuitive information such as the filling guide and the image visualization.

Meanwhile, the embodiments according to the present invention may be implemented in the form of program instructions that can be executed by computers, and may be recorded in computer readable media. The computer readable media may include program instructions, a data file, a data structure, or a combination thereof. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A system for producing stereoscopic images, comprising:
a movement area detecting unit examining a movement area for an object moved in an image, detecting/tracking changes of the movement area by dividing a front view and a background of the movement area, and providing result information;
a filling error processing unit filling a hole detected by the movement area detecting unit and correcting a filled filling region; and
a stereoscopic image visualizing unit visualizing a stereoscopic image corrected by the filling error processing unit.

2. The system of claim 1, wherein the movement area detecting unit includes:
a movement area examining unit calculating the movement area by using a difference between segmentation of the object and a change area of the segmented object;
a front view and background dividing unit processing the calculated movement area as a background for the object and processing the moved object as a front view;
a movement area change detecting unit examining whether the object and the movement area are changed for each frame; and
a movement area tracking unit tracking the object when the object is changed.

3. The system of claim 1, further comprising:
a filling guide unit providing a filling guide corresponding to result information based on the result information for the movement area,
wherein the filling error processing unit corrects the filling region based on the filling guide provided by the filling guide unit.

4. The system of claim 3, wherein the filling guide unit includes:
a boundary guide unit providing a visual image of a boundary portion of the object;
a filling method guide unit providing at least one filling method guide for the movement area;
a boundary blurring guide unit providing a guide for blurring the boundary area;
a filling candidate guide unit providing a predetermined filling method guide for a predetermined specific frame; and
a human factor guide unit providing an error allowance guide to a focus area and a non-focus area of the image based on recognition.

5. The system of claim 1, wherein the filling error processing unit includes:
a boundary information processing unit analyzing and processing boundary information in accordance with a predetermined value;
a filling method processing unit setting values required for interpolation, transform, and tracking by using information which is provided in advance and filling the movement area in accordance with the set values; and
a boundary blurring unit setting and processing a boundary blurring value in accordance with information which is provided in advance.

6. The system of claim 5, wherein the filling error processing unit further includes a filling information selecting unit filling and simulating the hole in accordance with predetermined filling information to provide the filled and simulated hole to a user.

7. The system of claim 1, wherein the stereoscopic image visualizing unit includes:
a depth information visualizing unit visualizing an initial depth feeling provided by the user and depth information utilized when the movement area is filled;
a stereoscopic image visualizing unit visualizing a stereoscopic image considering the movement area;
an unstable area visualizing unit determining a depth feeling in the image and visualizing an unstable area in the image based on the determined depth feeling; and
a final image visualizing unit visualizing a final image in which the movement area is filled.

8. A method for producing stereoscopic images, comprising:
examining a movement area for an object moved in an image, detecting/tracking changes of the movement area by dividing a front view and a background of the movement area, and providing result information;
filling a hole detected and correcting a filled filling region based on the result information; and
visualizing the corrected stereoscopic image.

9. The method of claim 8, wherein the providing of the result information includes:
calculating the movement area by using a difference between segmentation of the object and a change area of the segmented object;
processing the calculated movement area as a background for the object and processing the moved object as a front view;
examining whether the object and the movement area are changed for each frame; and
tracking the object when the object is changed.

10. The method of claim 8, further comprising:
providing a filling guide corresponding to result information based on the result information for the movement area,
wherein in the correcting, the filling region is corrected based on the filling guide.

11. The method of claim 10, wherein the providing of the filling guide includes:
providing a visible image of a boundary portion of the object;
providing at least one filling method guide for the movement area;
providing a guide for blurring the boundary area;
providing a predetermined filling method guide for a predetermined specific frame; and
providing an error allowance guide to a focus area and a non-focus area of the image based on recognition.

12. The method of claim 8, wherein the correcting includes:
analyzing and processing boundary information in accordance with a predetermined value;
setting values required for interpolation, transform, and tracking by using information which is provided in advance and filling the movement area in accordance with the set values;
setting and processing a boundary blurring value in accordance with information which is provided in advance; and
filling and simulating the hole in accordance with predetermined filling information to provide the filled and simulated hole to a user.

13. The method of claim 8, wherein the visualizing includes:
visualizing an initial depth feeling provided by the user and depth information utilized when the movement area is filled;
visualizing a stereoscopic image considering the movement area;
determining a depth feeling in the image and visualizing an unstable area in the image based on the determined depth feeling; and
visualizing a final image in which the movement area is filled.
